(19) United States
(12) Patent Application Publication
(10) Pub. No.: US 2023/0193694 A1
(43) Pub. Date: Jun. 22, 2023

(54) Percussion and Cutting Composite Drilling Tool

(71) Applicant: Sichuan DeepFast Oil Drilling Tools Co., Ltd, Chengdu (CN)

(72) Inventors: Yaodong ZHENG, Chengdu (CN); Wen ZHONG, Chengdu (CN); Heng LI, Chengdu (CN); Defa ZENG, Chengdu (CN); Yajun KONG, Chengdu (CN); Yiyuan ZHANG, Chengdu (CN); Zhouwen HE, Chengdu (CN); Yonggang LI, Yonggang (CN); Hongji ZHOU, Chengdu (CN); Liang ZHANG, Chengdu (CN); Shu LI, Chengdu (CN)

(21) Appl. No.: 17/656,203

(22) Filed: Mar. 23, 2022

(30) Foreign Application Priority Data
Dec. 17, 2021 (CN) 202111549462.5

(51) Int. Cl. E21B 6/04; E21B 10/36; E21B 10/42; E21B 10/567; E21B 10/55

(52) U.S. Cl. CPC E21B 6/04; E21B 10/36; E21B 10/42; E21B 10/567; E21B 10/55

(57) ABSTRACT

The disclosure discloses a percussion and cutting composite drilling tool, which relates to the field of drilling equipment and is mainly used to solve the problems of low working efficiency and high wear rate of drill bit existed in breaking rocks only by cutting effect. The main structure comprises a PDC drill bit and a percussion drill bit, which is characterized by a percussion structure directly connected to the percussion drill bit. The disclosure provides a percussion and cutting composite drilling tool, which is suitable for strata under different geological conditions and has higher construction efficiency and lower bit wear.

### TECHNICAL FIELD

The disclosure relates to the field of drilling equipment, in particular to a percussion and cutting composite drilling tool.

### BACKGROUND

Drilling is the work of using mechanical equipment to drill the strata into cylindrical holes of a certain depth. Drilling technology is widely applied in oil and gas exploration engineering, mining, geological drilling, construction engineering, tunnel engineering and many other fields, either to obtain material data buried underground, or to open up channels, or to observe geological dynamics, and it plays an indispensable role in the current social development.

The drill bit is a rock breaking tool used in drilling engineering to break rocks and form wellhole. The conventional drill bits used in current drilling engineering mainly include tricone drill bits, polycrystalline diamond composite sheet drill bits (i.e. PDC drill bits) and percussion-rotary drill bits (also known as rotary-percussion drill bits or bore bits).

The tricone drill bits mainly break rocks by crushing (break rocks by pressing tooth into rocks). The applicable stratum range is wide, but the energy utilization rate is not high and the rock breaking efficiency is relatively low.

PDC drill bit is a kind of bit that breaks rock by scraping or shearing the rock with polycrystalline diamond composite sheet (i.e. PDC tooth, also known as tooth). Because of its outstanding advantages in the performance of cutting elements and the method of rock breaking, PDC drill bits have significantly higher efficiency than tricone drill bits in soft to medium hard strata. At present, PDC drill bit is used more and more in drilling engineering, with increasing proportion. However, PDC drill bit still cannot adapt to strata with high hardness and abrasiveness and strata with serious heterogeneity.

The percussion-rotary drill bit is a fixed-tooth rock breaking tool used in percussion rotary drilling in conjunction with down-hole impactor (i.e. down-hole hammer). The structure of the percussion-rotary drill bit is similar to that of the. PDC drill bit. There is no movable component on the drill bit, and a certain number of cutting teeth that can cover the area to be broken at the bottom of the well are consolidated on the bit body. The main difference lies in that the cutting element of PDC drill bit is mainly PDC tooth, while the cutting element of percussion-rotary drill bit is mainly cemented carbide or diamond composite tooth with the similar shape of cone drill bit tooth.

The above-mentioned drill bits all have their own advantages, but there are also problems such as single method of rock breaking, low rock breaking efficiency and high wear rate of drill bits.

### SUMMARY

The disclosure aims to provide a percussion and cutting composite drilling tool to solve the problems of low working efficiency and high wear rate of drill bit when breaking rocks only by cutting effect of the PDC drill bit.

To realize the purpose of the disclosure, the disclosure discloses a percussion and cutting composite drilling tool, comprising a drill bit including a percussion drill, bit and a PDC drill bit, and a percussion structure including a rotating component, a jacking component and an axial force transmission component, and the rotating component is connected to a power unit. The power unit drives the rotating component to rotate, and the rotating component drives the jacking component to make jacking movement in the axial direction. The impact force of the axial movement is transmitted to the percussion drill bit through the axial force transmission component and the percussion drill bit starts to make axial percussion movement.

Furthermore, the rotating component comprises a cam, the jacking component comprises a roller and a roller seat, and the axial force transmission component comprises a transmission rod and a spring, with one end of the transmission rod is connected to the percussion drill bit, and the other end is connected to the roller seat. The spring is arranged on the transmission rod, and the roller is arranged, on the roller seat; one end face of the cam is concave and convex, and the roller contacts the concave and convex end face of the cam. The cam is an end face cam in spatial cams, with one flat end face and one concave and convex end face; The power unit drives the cam to rotate, and the friction force drives the roller to roll and move up and down along the concave and convex end face of the cam, further driving the roller seat to move up and down. When the roller is at the high point of the cam, the spring is compressed to accumulate force. When the roller is at the low point of the cam, the spring is stretched to release force, links the transmission rod to expand and contract axially, and drives the percussion drill bit at one end of the transmission rod to make percussion movement.

Furthermore, the PDC drill bit and the percussion drill bit are alternatively arranged. This mainly refers to the alternative arrangement of the blade on the PDC drill bit and the blade on the percussion drill bit. There is blade of the PDC drill bit between the two adjacent blades on the percussion drill bit, and there is blade of the percussion drill bit between the two adjacent blades on the PDC drill bit. The alternative arrangement allows the uniform and stable cutting, under the coordination of percussion breaking and fixed cutting. The drill bit is not easy to be damaged under uniform force, and the structure is very stable, therefore, the rock breaking effect is good. The blade combination of the PDC drill bit and the percussion drill bit can be “2+2”, “3+3” or “4+4”. The appropriate combination can be selected according to different strata and different working conditions to improve the rock breaking efficiency.

Furthermore, the concave and convex on the cam is continuous smooth wavy. The concave and convex is continuous smooth wavy, and the rolling of the roller on it is also smoother, which reduces the wear of the roller and makes the percussion reciprocating movement of the linkage percussion drill bit smoother.

Furthermore, the percussion drill bit is provided with a percussion tooth that is detachably connected to the bit body. The percussion tooth can be replaced with cylindrical, conical, spherical, polygonal and other shapes for different working conditions, which is conducive to improving work efficiency. When the percussion tooth is worn and deformed, it can also be replaced easily.

Furthermore, the percussion tooth is brazed to the bit body of the percussion drill bit. The melting point of the solder is lower than that of the percussion drill bit and the percussion tooth. Brazing can ensure firm connection, and the percussion tooth can be easily replaced without damaging the drill bit by heating the solder to the melting point.

Furthermore, the percussion tooth is made of cemented carbide. Cemented carbide has a series of excellent properties such as high hardness, wear resistance, good strength and toughness, heat resistance and corrosion resistance, especially its high hardness and wear resistance, which remain basically unchanged even at 500° C. and still has high hardness at 1,000° C., making it an ideal material for cutters and teeth.

Furthermore, the power unit connected to the rotating component comprises a hydraulic motor including a stator and a rotor. The rotor is placed in the inner cavity of the stator, a spiral structure for diversion is arranged on the inner wall of the stator, and a corresponding spiral structure is also arranged on the rotor. When the high-pressure drilling fluid passes through the hydraulic motor, due to the special spiral structure of the stator and the rotor, the hydraulic motor converts the high-pressure potential energy of the drilling fluid into the kinetic energy of the rotor, which drives the mandrel to rotate in linkage to the cam, and drives the cam to rotate, thus providing power for the cam.

Furthermore, a transmission structure is arranged between the rotor and the rotating component. The rotational movement of the rotor is transmitted to the rotating component through the transmission structure, and drives the rotational movement of the rotating component.

Furthermore, an internal flow passage is arranged on the transmission structure and the percussion structure, and a nozzle is arranged on the drill bit. The drilling fluid can be discharged from the nozzle on the drill bit to cool the cutting teeth, clean the drill bit, clean the bottom of the well and take away the rock debris, thus making the operation smoother.

The disclosure has the following beneficial effects:

I. The disclosure is provided with a percussion drill bit and a PDC drill bit, which work together when breaking the rocks, and are suitable for strata with different geological conditions, thus greatly improving the applicable working conditions of the drill bit;

II. The disclosure is additionally provided with a percussion drill bit on the basis of conventional PDC drill bit. The percussion drill bit applies high-frequency percussion on rocks and causes micro cracks in the rock stratum, which releases the confining pressure in the rock stratum, reduces the strength and toughness of the rocks, and changes the rock stratum breaking from ductile fracture to brittle fracture. Therefore, PDC drill bit can more easily cut into the rock stratum, improving the working efficiency of the drill bits;

III. The percussion structure of the disclosure consists of the circumferential rotation of the rotating component in linkage to the axial movement of the percussion drill bit, which has the advantages of ingenious structure, simple manufacture and easy maintenance.

### BRIEF DESCRIPTION OF DRAWINGS

FIG. 1: a structure diagram of the disclosure;

FIG. 2: a structure diagram of working connection state of the disclosure;

FIG. 3: an arrangement diagram of the PDC drill bit and the percussion drill bit of the disclosure.

Marks and names of corresponding parts and components as shown on the drawings:

1-drill bit, 1-1-percussion drill bit, 1-1.1-percussion tooth, 1-2-PDC drill bit, 1-3-nozzle, 2-percussion structure, 2-1-spring, 2-2-cam, 2-3-roller, 2-4-roller seat, 2-5-transmission rod, 3-transmission structure, 4-hydraulic motor, 4-1-stator, 4-2-rotor, 5-flow passage, 5-1-external flow passage, 5-2-internal flow passage.

### DETAILED DESCRIPTION

Technical solutions in embodiments of the disclosure will be clearly and completely described with reference to the drawings in the embodiments of the disclosure. Apparently, the embodiments described below are merely part, not all, of the embodiments of the disclosure. All other embodiments obtained by persons of ordinary skill in the art based on the embodiments of the disclosure without creative efforts shall fall within the protection scope of the disclosure.

### Embodiment I

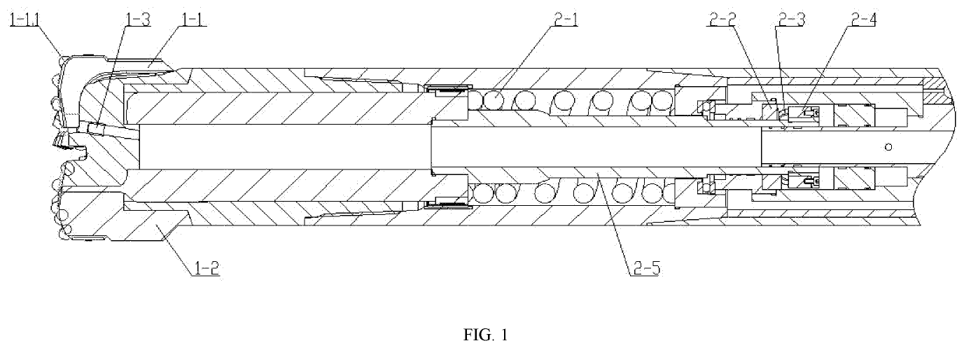

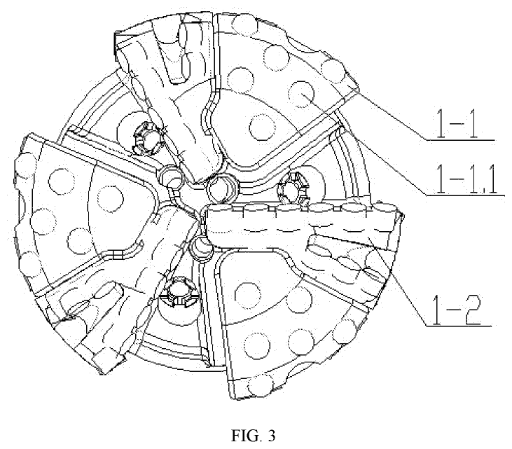

FIG. 1 and FIG. 3 show a percussion and cutting composite drilling tool of the disclosure, comprising the drill bit 1, the percussion structure 2, the transmission structure 3 and the hydraulic motor 4. Drill bit 1 includes the percussion drill bit 1-1 and the PDC drill bit 1-2, in which the percussion drill bit 1-1 breaks the rocks by percussion, while the PDC drill bit 1-2 breaks the rocks by rotation and cutting. Both the transmission structure 3 and the hydraulic motor 4 are located inside the drilling tool housing, the percussion drill bit 1-1 is installed at the output end of the percussion structure 2, and the PDC drill bit 1-2 is installed on the drilling tool housing. The PDC drill bit 1-2 and the percussion drill bit 1-1 are alternatively arranged. Specifically, both the percussion drill bit 1-1 and the PDC drill bit 1-2 have multiple blades. Multiple blades on the percussion drill bit 1-1 are alternatively arranged with multiple blades on the PDC drill bit 1-2. There is the blade of the PDC drill bit 1-2 between two adjacent blades on the percussion drill bit 1-1, and there is the blade of the percussion drill bit 1-1 between two adjacent blades on the PDC drill bit 1-2. In the disclosure, the hydraulic motor 4 is used as a power source to drive the percussion structure 2 through the transmission of the transmission structure 3, so that the percussion structure 2 changes the rotational action of the hydraulic motor 4 into the percussion action of the reciprocating movement, and the percussion action caused by the percussion structure 2 is transmitted to the percussion drill bit 1-1, making the percussion drill bit 1-1 rotate with the PDC drill bit 1-2 while achieving the percussion breaking. The percussion tooth 1-1.1 on the percussion drill bit 1-1 is brazed to the bit body of the percussion drill bit 1-1 to facilitate the replacement of percussion tooth 1-1.1 in different shapes according to different geological conditions. The percussion drill bit 1-1 is directly connected to the percussion structure 2, which includes the rotating component, the jacking component and the axial force transmission component. The rotating component is connected to the power unit through the transmission structure 3, the axial transmission component is connected to the percussion drill bit 1-1, the jacking component is connected between the axial transmission component and the rotating component, and the rotating component rotates in the drilling tool housing. The rotational movement of the rotating component changes to reciprocating movement along the axis of the drilling tool housing through the jacking component. The axial force transmission component transmits the reciprocating movement of the jacking component to the percussion drill bit 1-1, thus driving the percussion drill bit 1-1 to reciprocate, impact and break the rocks.

The rotating component includes a cam 2-2, which is connected to the output end of the transmission structure 3, so that the hydraulic motor 4 drives the cam 2-2 to rotate through the transmission structure 3 when rotating. The hydraulic motor 4 and the transmission structure 3 cannot move along the axial direction in the drilling tool housing. Therefore, when the cam 2-2 rotates, the cam 2-2 can only rotate in the drilling tool housing, but cannot move along the axial direction in the drilling tool housing. The jacking component includes the roller 2-3 and the roller seat 2-4, the axial force transmission component includes the transmission rod 2-5 and the spring 2-1. One end of the transmission rod 2-5 is connected to the percussion drill bit 1-1, the other end of the transmission rod 2-5 is connected to the roller seat 2-4, and the end of the transmission rod 2-5 close to the percussion drill bit 1-1 has a limit step; at the same time, the spring 2-1 is sleeved on the transmission rod 2-5, and can reciprocate on the transmission rod 2-5, and the roller 2-3 is set on the roller seat 2-4 and arranged on the end face near the jacking component on the roller seat 2-4. The roller 2-3 can fully rotate on the roller seat 2-4, with one end of the spring 2-1 against the roller 2-3, and the other end of the spring 2-1 against the limit step on the transmission rod 2-5. The cam 2-2 is located below the roller 2-3, and one end face of the cam 2-2 is continuous smooth wavy concave and convex. The roller 2-3 fits to the continuous smooth wavy end face of the cam 2-2, so that the roller 2-3 is in contact with the concave and convex end face of the cam 2-2. The power unit drives the cam 2-2 to rotate, and drives the roller 2-3 to roll and move up and down along the concave and convex end face of the cam 2-2 under the friction force, further driving the roller seat 2-4 to move up and down and driving the transmission rod 2-5 to move up and down simultaneously while the roller seat 2-4 moves up and down. As the cam 2-2 does not move axially in the drilling tool housing, when the transmission rod 2-5 moves up and down, the end of the spring 2-1 against the cam 2-2 has no axial displacement, so that the end of the spring 2-1 against the cam 2-2 is axially static relative to the drilling tool housing. When the roller 2-3 is at the high point of the cam 2-2, the distance between the transmission rod 2-5 and the power unit is minimal, the limit step on the transmission rod 2-5 pushes the spring 2-1 to compress towards the power unit, so that the spring 2-1 is contracted to accumulate force. When the roller 2-3 is at the low point of the cam 2-2, the cam 2-2 loses the jacking force on the roller 2-3, so that the spring 2-1 is stretched to release the force. The spring 2-1 pushes the transmission rod 2-5 forward through its own elastic force, links the transmission rod to expand and contract axially, and drives the percussion drill bit 1-1 at one end of the transmission rod 2-5 to make percussion movement. The distance between the transmission rod 2-5 and the power unit is the maximum.

In the disclosure, as the multiple blades on the percussion drill bit 1-1 are alternatively arranged with the multiple blades on the PDC drill bit 1-2, when the PDC drill bit 1-2 rotates, the percussion drill bit 1-1 is required to rotate synchronously for rotation and cutting while percussion breaking of the percussion drill bit 1-1, that is, when the transmission rod 2-5 drives the percussion drill bit 1-1 for percussion breaking, the ratio of the speed at which the power unit drives the cam 2-2 to the speed at which the percussion drill bit 1-1 drives the transmission rod 2-5 shall make the rotation speed of the percussion, drill bit 1-1 equal to that of the PDC drill bit 1-2.

In the disclosure, the rotating side of the blade on the PDC drill bit 1-2 can be fitted to the blade on the percussion drill bit 1-1, so that the blade on PDC drill bit 1-2 can be fitted to the blade on the percussion drill bit 1-1 when rotating and the PDC drill bit 1-2 can drive the percussion bit 1-1 to rotate synchronously through the blade on the PDC drill bit 1-2, and avoid the concentration of thrust transmitted to the percussion drill bit 1-1 by the PDC drill bit 1-2 during rotation at the junction between the percussion drill bit 1-1 and the transmission rod 2-5, making the junction between the percussion drill bit 1-1 and the transmission rod 2-5 more firm. Here, the rotating side of the blade on PDC drill bit 1-2 refers to the front surface of the blade when the rotation direction of the PDC drill bit 1-2 is the axial direction. For example, when the rotation direction of the PDC drill bit 1-2 is clockwise, the rotating side of the blade is the left side of the blade; if the rotation direction of the PDC drill bit 1-2 is anticlockwise, the rotating side of the blade is the right side of the blade.

In the disclosure, the transmission rod 2-5 is hollow, with an internal flow passage 5-2, and the drill bit 1 is provided with a nozzle 1-3, which is connected to the internal flow passage 5-2 and can discharge the drilling fluid from the drill bit 1 to wash away the broken rocks, thus making the operation smoother.

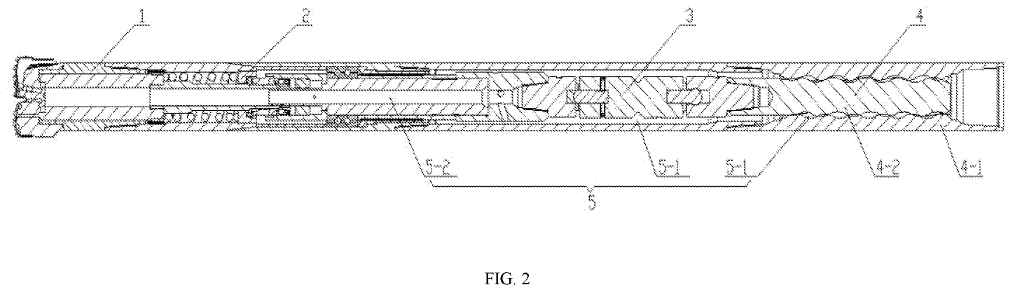

As shown in FIG. 2, the power unit connected with the cam 2-2 includes a hydraulic motor 4, which is connected to the cam 2-2 through the transmission structure 3. The hydraulic motor 4 includes a stator 4-1 and a rotor 4-2, and the rotor 4-2 is arranged in the inner cavity of the stator 4-1. A spiral structure for diversion is arranged on the inner wall of the stator 4-1, and a corresponding spiral structure is also arranged on the rotor 4-2. When the high-pressure drilling fluid enters the hydraulic motor 4, it forms a vortex force under the diversion of the threaded structure on the inner wall of the stator 4-1, then drives the rotor 4-2 to rotate through the spiral structure on it, and further drives the cam 2-2. The transmission structure 3 is a universal shaft, through which the rotor 4-2 links the cam 2-2, drives it to rotate, and provides power for the rotation of the cam 2-2. An external flow passage 5-1 is formed between the stator 4-1 and the rotor 4-2 and between the universal shaft and the housing. An internal flow passage 5-2 is arranged on the transmission structure 3 and the percussion structure 2. The external flow passage 5-1 and the internal flow passage 5-2 are connected to form the flow passage 5. A nozzle 1-3 is arranged on the drill bit 1, which is the outlet of the internal flow passage 5-2.

When using, the percussion and cutting composite drilling tool is connected to the end of the drill string. After entering the well, the drill bit gradually approaches and reaches the bottom of the well. The driving equipment of circulating fluid (when the circulating fluid is drilling fluid, the driving equipment is drilling pump; when the circulating fluid is gas or mainly gas, the driving equipment is compressor) is started to circulate the circulating fluid inside and outside the drill string. When the drilling pressure is applied on the drill bit 1, the rotary drilling is started, and the PDC drill bit 1-2 on the drill bit starts to break the rocks at the bottom of well. At the same time, as the circulating fluid has started to circulate, driven by the circulating fluid in the drill string, the hydraulic motor 4 drives the cam 2-2 to rotate, and drives the roller 2-3 to roll and move up and down along the concave and convex end face of the cam 2-2 under the friction force. When the roller 2-3 is at the high point of the cam 2-2, the spring 2-1 is compressed to accumulate force. When the roller 2-3 is at the low point of the cam 2-2, the spring 2-1 is stretched to release force, links the transmission rod 2-5 to expand and contract axially, and drives the percussion drill bit at one end of the transmission rod 2-5 to make percussion movement, thus achieving the percussion breaking of rock at the bottom of the well by the percussion drill bit 1-1. The circulating fluid flows through the percussion structure 2 and then flows out of the drill bit nozzle 1-3 through the internal flow passage 5-2 to cool the cutting teeth, clean the drill bit, clean the bottom of the well and take away the rock debris. The rock breaking operations of PDC drill bit 1-2 and percussion drill bit 1-1 are relatively independent. The percussion drill bit 1-1 relies on the impulse load of percussion tooth 1-1.1 to break the rocks at a certain frequency. The broken rocks increase the bit penetration of the PDC drill bit 1-2, improve the rock breaking efficiency and reduce the wear of the PDC drill bit 1-2.

### Embodiment II

The protection scope of the disclosure not only covers the mechanism mentioned in Embodiment II. When the rotating component in Embodiment I is an annular boss with two smooth end faces, and the jacking component includes a cam roller and a roller seat, the annular boss rotates and drives the cam roller to roll under the action of friction force. The radius change of cam roller drives the axial movement of the roller seat, and transmits the force of axial movement to the percussion drill bit through the axial transmission component, thus achieving the axial percussion movement of the percussion drill bit.

The embodiments above are only the preferred embodiments for the disclosure and not used to restrict the disclosure. For those skilled in the field, various modifications and changes can be made to the disclosure. Any modification, equivalent replacement and improvement within the concept and principle of the disclosure, are covered by the range of protection of the disclosure.

1. A percussion and cutting composite drilling tool, comprising a drill bit (1) including a percussion drill bit (1-1) and a PDC drill bit (1-2), and a percussion structure (2) directly connected to the percussion drill bit (1-1), wherein the percussion structure (2) comprises a rotating component, a jacking component and an axial force transmission component arranged in sequence and coaxially, the percussion drill bit (1-1) is connected to one end of the axial force transmission component, the other end of the axial force transmission component is connected to one end of the jacking component, the other end of the jacking component is drive connected to the rotating component, and the rotating component is connected to the power unit.

2. The percussion and cutting composite drilling tool according to claim 1, wherein the rotating component comprises a cam (2-2), the jacking component comprises a roller (2-3) and a roller seat (2-4), the axial force transmission component comprises a transmission rod (2-5) and a spring (2-1), with one end of the transmission rod (2-5) connected to the percussion drill bit (1-1) and the other end connected to the roller seat (2-4), the spring (2-1) is arranged on the transmission rod (2-5), and the roller (2-3) is arranged on the roller seat (2-4); one end face of the cam (2-2) is concave and convex, and the roller (2-3) contacts the concave and convex end face of the cam (2-2).

3. The percussion and cutting composite drilling tool according to claim 2, wherein the cam (2-2) is located below the roller (2-3) and the upper end of the spring (2-1) is located below the cam (2-2) and remains axially static relative to the drilling tool housing, and the lower end of the spring (2-1) participates in the percussion movement of the percussion drill bit (1-1).

4. The percussion and cutting composite drilling tool according to claim 1, wherein the PDC drill bit (1-2) is alternatively arranged with the percussion drill bit (1-1).

5. The percussion and cutting composite drilling tool according to claim 4, wherein the blade combination of the PDC drill bit (1-2) and the percussion drill bit (1-1) is in “2+2” or “3+3” or “4+4”.

6. The percussion and cutting composite drilling tool according to claim 2, wherein the concave and convex on the cam (2-2) are continuous smooth wavy.

7. The percussion and cutting composite drilling tool according to claim 1 , wherein the percussion drill bit (1-1) is provided with a percussion tooth (1-1.1) that is detachably connected to the bit body.

8. The percussion and cutting composite drilling tool according to claim 7, wherein the percussion tooth (1-1.1) is brazed to the bit body of the percussion drill bit (1-1).

9. The percussion and cutting composite drilling tool according to claim 7, wherein the percussion tooth (1-1.1) is made of cemented carbide.

10. The percussion and cutting composite drilling tool according to claim 2, wherein the power unit connected to the rotating component comprises a hydraulic motor (4) including a stator (4-1) and a rotor (4-2), the rotor (4-2) is arranged in the inner cavity of the stator (4-1), a spiral structure for diversion is arranged on the inner wall of the stator (4-1), a corresponding spiral structure is also arranged on the rotor (4-2).

11. The percussion and cutting composite drilling tool according to claim 10, wherein the rotor (4-2) is connected to the cam (2-2) and the cam (2-2) remains axially static relative to the drilling tool, housing.

12. The percussion and cutting composite drilling tool according to claim 10, wherein a transmission structure (3) is arranged between the rotor (4-2) and the rotating component.

13. The percussion and cutting composite drilling tool according to claim 10, wherein an internal flow passage (5-2) is arranged on the transmission structure (3) and the percussion structure (2), and a nozzle (1-3) is arranged on the drill bit (1).

14. The percussion and cutting composite drilling tool according to claim 1, wherein the percussion drill bit (1-1) rotates with the PDC drill bit (1-2) while its percussion.

15. The percussion and cutting composite drilling tool according to claim 14, wherein the ratio of the speed at which the power unit drives the cam (2-2) to the speed at which the percussion drill bit (1-1) drives the transmission rod (2-5) shall make the rotation speed of the percussion drill bit (1-1) equal to that of the PDC drill bit (1-2).

16. The percussion and cutting composite drilling tool according to claim 1, wherein the rotating side of the blade on the PDC drill bit (1-2) can be fitted to the blade on the percussion drill bit (1-1).
